(19) United States
(12) Patent Application Publication
(10) Pub. No.: US 2005/0004968 A1
(43) Pub. Date: Jan. 6, 2005

(54) System, apparatus, and method for a mobile information server

(76) Inventors: Jari Mononen, Ruutana (FI); Petri Nykanen, Nokia (FI); Seppo Pohja, Tampere (FI); Mikko Kolehmainen, Jarvenpaa (FI); Ulla Konkarikoski, Tampere (FI)

Correspondence Address: Crawford Maunu PLLC, Suite 390, 1270 Northland Drive, St. Paul, MN, 55120, US

(21) Appl. No.: 10/612,706

(22) Filed: Jul. 2, 2003

(51) Int. Cl. G06F 15/16

(52) U.S. Cl. 709/200

(57) ABSTRACT

Mobile Information Server (MIS) (704) provides mobile information services to network (702). Local data stored in server directory (708) generated from MIS (704), such as image data from imagery device (722) or telemetry data from telemetry device (712), is network accessible through request handler (706). Additionally, MIS (704) provides access to external devices (714-720) via Common Gateway Interface (CGI) 710. Thus, MIS (704) acts as a mobile information server to network (702) for local, or proximately located information sources, even when the user of MIS (704) is not available.

### FIELD OF THE INVENTION

This invention relates in general to information servers, and more particularly, to mobile information servers that provide access to local information or to proximately located information sources.

### BACKGROUND OF THE INVENTION

The role of the mobile terminal in today's communications networks is rapidly becoming more and more integrated with the Internet model, as the mobile terminal adapts to user's demands for added functionality. The mobile terminal, for example, has evolved from a simple device offering voice only capability to a device fully capable of browsing the Internet and providing rich content communication to include voice, data, imaging, video, etc.

Current communication methods with mobile terminals require active user intervention. Specifically, today's mobile terminals essentially allow contact with the user of the mobile terminals through the use of voice or data calls, or through the use of various messaging technologies such as the Short Messaging Service (SMS) and Multimedia Messaging Service (MMS). Communication via prior art mobile terminals, therefore, requires attention that is directly controlled and monitored by the user of the mobile terminal.

Generally speaking, user intervention is required in order to obtain information from the mobile terminal that may be of importance to other users operating within the network. In particular, one form of important information concerning users of mobile terminals is their presence information. Presence information allows mobile terminal users the ability to share their availability, whereabouts, intentions, preferences, and even emotions. Users are interested in what the party with whom they wish to communicate is up to before they place a call or message. Presence makes for a more refined means of communication, by showing the initiating party whether the person at the other end is available and willing to communicate. Presence may also be used to communicate information on: when; with whom; and by what means the user is able or willing to communicate.

Presence information of one user, however, needs to be communicated before it can be made known to the other users. One method used today to communicate presence information is through the use of Instant Messaging (IM). IM is a way to send short, simple messages that are delivered immediately to online users. Transferring presence information via IM in a mobile application expands its usefulness beyond merely knowing whether users are on line or not, but it can also be used to indicate their location, their need for privacy or willingness to communicate, and a rough idea of their moods and sentiments. IM used in conjunction with presence information introduces a “see before you connect” idea, where a user wanting to communicate with another user first checks the status and availability of the other user and then chooses the most appropriate way to communicate. In order for the “see before you connect” idea to work, however, the other user must first transmit his or her status and availability via IM, so that users wanting to communicate with them may determine the best way to do so.

There exists other information contained within each user's mobile terminal that, to an increasing extent, could be made available to other users. For example, prior art mobile terminals having imaging capability, may capture images that may be shared with others in the network. Additionally,.prior art mobile terminals having proximity connection capability, may access information contained within devices that are in close proximity and may likewise share that information with others in the network. In prior art mobile terminals, however, this other information is likewise required to be transmitted through, for example, IM to make it available to other users in the network.

Accordingly, there is a need in the communications industry for a system, apparatus and method that allows sharing of information by a mobile terminal without the required interaction of its user. In particular, interesting information either contained within the mobile terminal or information that may be accessed by proximity connections to the mobile terminal, should be made available to the network even when the user is unavailable to transmit such information.

### SUMMARY OF THE INVENTION

To overcome limitations in the prior art, and to overcome other limitations that will become apparent upon reading and understanding the present specification, the present invention discloses a system, method, and apparatus for providing a mobile information server.

In accordance with one embodiment of the invention, a mobile information system to provide information to network entities within a network is provided. The mobile information system comprises a mobile information server arranged to receive addressed information requests from the network entities, and at least one information source. The mobile information server facilitates information exchange from the at least one information source in response to the addressed information requests from the network entities.

In accordance with another embodiment of the invention, a mobile terminal wirelessly coupled to a network which includes a network element capable of requesting information from the mobile terminal through the use of addressed requests to the mobile terminal is provided. The mobile terminal comprises a memory capable of storing at least a protocol module, a server directory containing requested information, and a Common Gateway Interface (CGI). The mobile terminal further comprises a processor coupled to the memory and configured by the protocol module to provide the requested information to the network element in response to the information request, and a transceiver configured to facilitate the requested information exchange with the network element.

In accordance with another embodiment of the invention, a computer-readable medium having instructions stored thereon which are executable by a mobile information server for facilitating information transfer to network elements is provided. The instructions perform steps comprising receiving information requests from the network elements, determining a source for the information requested, accessing the information from the determined source, and conducting a transfer of the requested information to the network elements.

In accordance with another embodiment of the invention, a method of providing information from a mobile server to requesting network elements is provided. The method comprises receiving information requests from the network elements by the mobile server, determining a source for the information requested, accessing the information from the determined source, and transferring the requested information to the network elements from the mobile server.

These and various other advantages and features of novelty which characterize the invention are pointed out with greater particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1 illustrates and exemplary system architecture in accordance with the present invention;

FIG. 2 illustrates an IP based protocol stack utilized by the system architecture of FIG. 1;

FIG. 3 illustrates a method of providing security access processing according to the present invention;

FIG. 4A illustrates a video conferencing scenario in accordance with the present invention;

FIG. 4B illustrates an alternate embodiment of a mobile server according to the principles of the present invention operating as a content server for streamed content;

FIG. 5 illustrates a Real-Time Streaming Protocol (RTSP) message flow in accordance with the present invention;

FIG. 6 illustrates a mobile server relationship in accordance with the present invention;

FIG. 7 is a network diagram illustrating external device access from the mobile information server in accordance with the present invention;

FIG. 8 illustrates a representative mobile computing arrangement suitable for performing mobile server functions in accordance with the present invention; and

FIG. 9 illustrates an information request processing method in accordance with the present invention.

### DETAILED DESCRIPTION OF THE INVENTION

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention is directed to a system, apparatus, and method that allows a mobile terminal to function as an information server. The mobile information server provides a mechanized service consumption model where conventional services and data may be offered by the mobile terminal without necessarily involving human interaction. Client systems interact with the mobile information server using a model based on a rich set of meta-data made possible with interpretable Extensible Markup Language (XML). The transport is typically HyperText Transfer Protocol (HTTP), Wireless Application Protocol (WAP), or alternately, it is based upon the Simple Mail Transfer Protocol (SMTP). Accordingly, the mobile information server according to the present invention is well suited for the ALL-Internet Protocol (IP) architecture for future ALL-IP networks, but is equally well suited to function within legacy mobile communication systems such as the Global System for Mobile Communications (GSM), General Packet Radio Service (GPRS), and early Third Generation (3G) systems.

The Web services provided by the mobile information server of the present invention provides sets of services and information over the Internet and the Mobile domain to appropriate service consumers. Web services are services provided over a session layer, e.g., HTTP, SMTP, File Transfer Protocol (FTP), or another similar Internet technology. Web services utilize certain, industry standard software technologies, such as XML, XML Protocol (XMLP), Simple Object Access Protocol (SOAP), Web Services Description Language (WSDL), and Universal Description, Discovery, and Integration (UDDI). The Web services are not specific to any particular mobile terminal platform and they are offered in a manner that allows: 1.) discovery of the mobile services/information offered by the mobile server; 2.) interpretation of the service/information offerings from a registry of services; and 3.) invocation of service/information requests. with the appropriate request parameters that facilitates correct response interpretation.

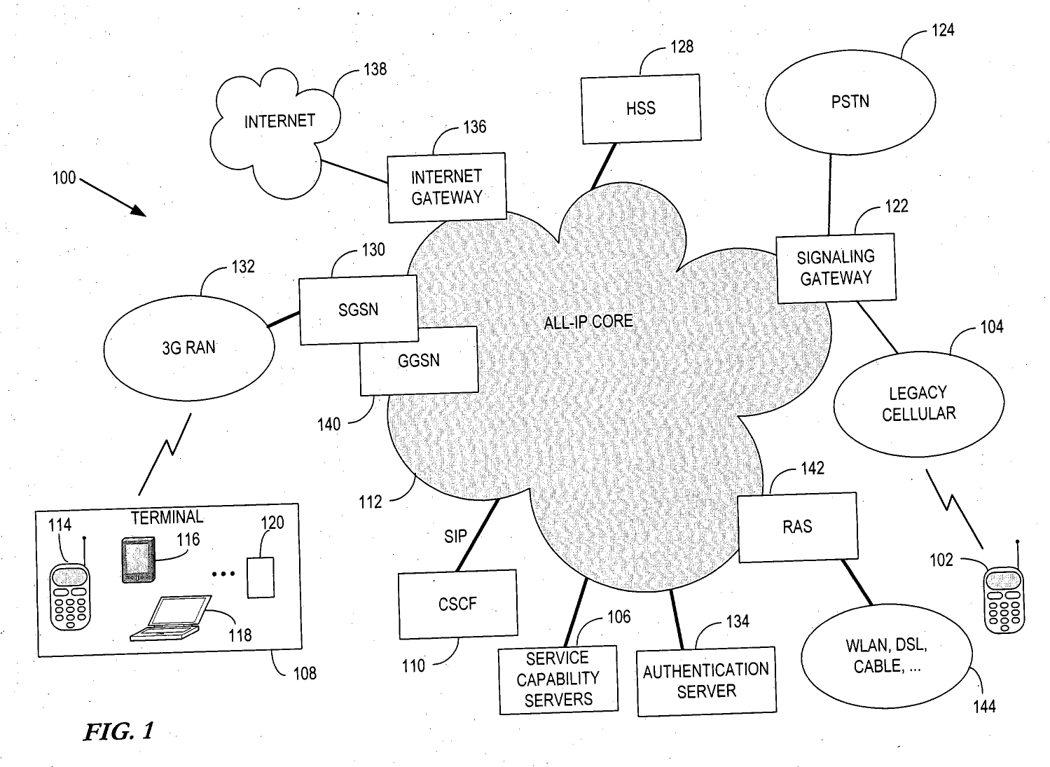

An exemplary system level diagram of ALL-IP system 100 architecture in accordance with the present invention is illustrated in FIG. 1. ALL-IP core 112 provides the common, IP based signaling core utilized by system 100 to integrate various fixed, mobile, and Internet networks. ALL-IP core 112 allows all communication services to be carried over a single network infrastructure, thus enabling the integration of voice, data, and multimedia services. Further, ALL-IP core 112 allows network resources to be used more efficiently, where increased capacity may be deployed as necessary to meet demand. It should be noted that mobile information services/information according to the present invention may be implemented through the use of IP enabled mobile terminals 108, but may also be implemented through the use of legacy mobile terminals 102 as well.

ALL-IP system 100 is optimized to support multimedia services, where Call State Control Function (CSCF) 110 implementing Session Initiation Protocol (SIP) is a key ingredient in providing the multimedia services to all IP enabled devices. Although SIP's primary objective was meant for multimedia sessions, its scope may be extended to presence, gaming, and IM, as well. Numerous applications can be implemented using SIP, allowing the combination of traditional telephony with messaging and multimedia. For example, SIP can enhance the concept of caller identification from one of simply displaying the number of the calling party to terminal 108, for example, to one of rich content identification. The calling party may, for example, display his personalized logo or business card information to terminal 108 and deliver the subject of the pending call in text, video, or picture format, depending upon the capabilities of terminal 108.

Wireless terminal 108 may represent any number of ALL-IP mobile communication devices, such as a cellular telephone 114, a personal digital assistant (PDA) 116, a notebook or laptop computer 118, or any other type of ALL-IP wireless terminal represented by device 120. 3G Radio Access Network (RAN) 132 represents a combination of all mobile radio standards, such as GSM/Enhanced Data Rates for Global Evolution (EDGE) and Wideband Code Division Multiple Access (WCDMA). Each mobile radio standard having its own distinct network architectures and transport mechanisms that are fully integrated using the IP protocol, where Serving GPRS Support Node (SGSN) 130 and Gateway GPRS Support Node 140 provides the RAN interface to ALL-IP core 112.

Network 144 provides Wireless Local Area Network (WLAN), Digital Subscriber Line (DSL), and cable access to ALL-IP core 112 by Remote Access Server (RAS) 142. RAS 142 may include, for example, a Digital Subscriber Line Access Multiplexer (DSLAM) or a cable head end controller. To provide access to ALL-IP core 112 over a cable network, a head-end controller device (not shown) within RAS 142 connects to an IP router (not shown) that sends and receives the data from ALL-IP core 112. The controller interprets the data it receives from individual customers and keeps track of the services offered to each of them. The controller also modulates the data received from ALL-IP core 112 so that the head-end equipment can send it to a specific cable subscriber within network 144.

ALL-IP system 100 supports Legacy Cellular systems 104 that offers communication support to non ALL-IP terminal 102, for example. Signaling gateway 122 performs all necessary Signaling System No. 7 (SS7) and Mobile Application Part (MAP) signaling conversions as necessary to provide SS7 over IP access from PSTN 124 and MAP over IP access from Legacy Cellular system 104 to ALL-IP core 112. In addition, signaling gateway 122 provides Short Message Service Center (SMSC) support and Multimedia Message Service Center (MMSC) support for any SMS and MMS operations as required by mobile terminal 102.

Internet 138 access from ALL-IP core 112 is provided through internet gateway 136 to allow accesses defined by Uniform Resource Locator (URL) and Uniform Resource Identifier (URI) address definitions. Home Subscriber Server (HSS) 128 provides ALL-IP core 112 with the many database functions that are required in ALL-IP networks. HSS 128, for example, includes Home Location Register (HLR) and Domain Name Server (DNS) operations.

Service capability servers 106 provide consumer applications and services that are not easily provided within the circuit switched or packet core networks by themselves. Service groups having major relevance in 3G ALL-IP networks include information and entertainment content providers, communication, productivity enhancing services and business solutions. Accordingly, services that are timely, personalized, simple to complete, and location specific are provided to all consumers of ALL-IP system 100.

Authentication server 134 provides localized identification, authentication, and authorization functions for any terminal having access to ALL-IP core 112. Authentication server 134 is hierarchically attached to ALL-IP core via, for example, the IP, SIP, Extensible Authentication Protocol (EAP), or HTTP stacks and it provides the required authentication mechanisms depending upon the bearer's capability used at any particular instant. Authentication server 134 performs the multiple algorithms and creation of the appropriate messages that encapsulate the results of those algorithms depending on the protocol that requested the authentications. For example, if authentication is requested from a WLAN access point, e.g., RAS 142, authentication server 134 receives information about the algorithm and protocol and will return the security tokens formatted into the indicated protocol such as EAP.

Similarly, if the requesting protocol is SIP, authentication server 134 accesses the SIM information, either directly or via a SIM server (not shown), and performs the appropriate calculation for obtaining the integrity and confidentiality keys requested by the IP Multimedia Subsystem (IMS). The integrity and confidentiality keys are then formatted into the correct SIP structure that is included in the SIP header. Alternately, if authentication is requested via a SIP procedure for accessing services provided within ALL-IP core 112, then calculation of the security credentials may involve a different algorithm and the results would involve a different structure that would be placed into the SIP header.

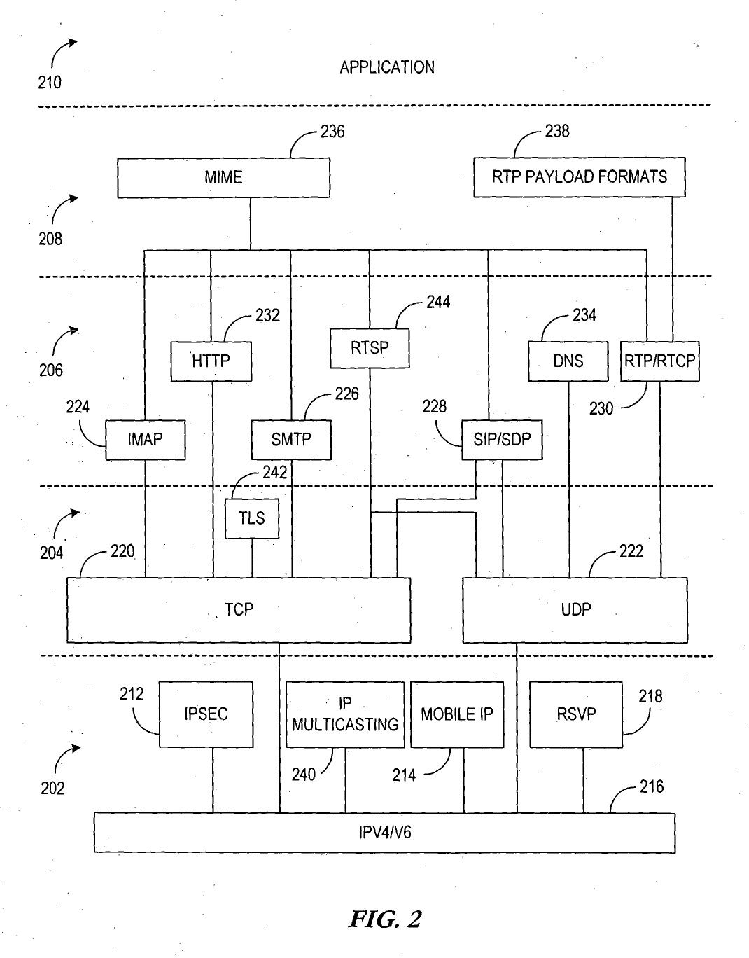

SIP enabled call/authentication control within ALL-IP system 100 is provided by CSCF 110, where SIP is hierarchically located in the session layer of the Open System Integration (OSI) model of protocol stack communication. FIG. 2 illustrates SIP and related protocols as they are hierarchically related within the Internet Multimedia Architecture (IMA) as defined by the Internet Engineering Task Force (IETF). Internet layer 202 resides at the bottom of the IMA layered protocol stack above the physical layer (not shown). A portion of Internet layer 202 is comprised of IP layer 216, e.g., IPv4 or IPv6, which runs over every network technology and provides the basic connectionless, packet delivery service for any layer above it. Included with the IP layer is a mobility mechanism, Mobile IP 214, which allows mobile terminals to move freely between different mobile networks. Mobile IP 214 hides the changes in the point-of-attachment to the network from the layers above. Mobile IP 214 also enables mobile devices to receive IP packets via their home networks regardless of which network they happen to be roaming in at the time.

A multicasting agent, IP Multicasting 240, also resides within the IP layer which allows, for example, a mobile subscriber to deliver a packet simultaneously to multiple receivers, easing the scalability of large conferences or media streaming. Security is also provided within the IP layer, i.e., IPSec 212, which provides confidentiality and integrity protection for all traffic. RSVP 218 is a signaling protocol for flow state establishment. A flow is a stream of packets classified by a flow classifier where each packet is subject to a queuing policy. Each packet may be considered individually, for example, to check their conformance to the bandwidth limit associated with each packet in the packet stream.

Above the IP layer resides transport protocol layer 204, which operates end-to-end between hosts or terminals. Exemplary transport protocols include Transmission Control Protocol (TCP) 220 that allows connection-oriented reliable delivery with congestion control and retransmission for data recovery. Another transport protocol is User Datagram Protocol (UDP) 222, which allows a connectionless datagram service where connection setup is not needed or when overhead should be reduced. Another transport within transport layer 204 is the Stream Control Transmission Protocol (SCTP) (not shown) which provides connection-oriented service to multiple interfaces/IP addresses. SCTP allows multiple streams to avoid head of line blocking and is also message oriented, so that protocols running on top of SCTP do not need to worry about message alignment. Transport Layer Security (TLS) 242 provides communications privacy over connection-oriented transport protocols. TLS 242 allows one or both of the end points to be authenticated with certificates and provides keys enabling encryption of all the data in the transport connection. A common use for TLS 242 and its predecessor, Secure Sockets Layer (SSL), is to secure Web transactions.

Above transport protocol layer 204 resides session protocol layer 206. HTTP 232 performs session control for browsing and enables management of transport layer connections for content transfer. The connections are addressed either to a proxy HTTP server or directly to the server identified by the host part of the Uniform Resource Locator (URL). E-mail type store and retrieve messaging sessions are managed with SMTP 226 and the Internet Message Access Protocol (IMAP) 224. Layers above transport layer 204 can utilize the Internet Domain Name System (DNS) to translate mnemonic names to numeric addresses required by those layers. Voice and other multimedia content, such as video or animation for example, are transported by Real-Time Transport Protocol/Real-Time Transport Control Protocol (RTP/RTCP) 230, which runs on top of UDP transport 222. RTP/RTCP 230 also offers synchronization of data streams it carries by including a sequence number and a timestamp header. Real Time Streaming Protocol (RTSP) 244 forms the basis for most streaming technologies.

Session Initiation Protocol/Session Description Protocol (SIP/SDP) 228 is utilized for instant messaging and rich call session control. SIP/SDP 228 facilitates end-to-end capability negotiation for real-time multimedia communication sessions, where the real-time media is transported over RTP with the aid of RTP/RTCP 230. Addressing for SIP sessions is based on the SIP URLs. SIP user agents are reachable through their registration to the rich session control element in the home network, which is identified by the domain portion of the consumer's SIP URL. Real time transport resources are managed independently by each session participant for his or her own access network.

Presentation layer 208 comprises Multipurpose Internet Mail Extensions (MIME) 236, which defines the rules for labeling and transmission of different data types within SMTP messages and their attachments. MIME 236 also forms the basis for the transmission of streaming data, such as audio and video messages. RTP Payload Formats 238 supports grouping of payload types for specific applications, such as for audio/video conferencing. Payload types identify specific codecs, such as for Moving Pictures Expert Group Version 4 (MPEG-4) streams, or Enhanced Variable Rate Codec (EVRC) speech. Application layer 210 is situated on top of the transport and session layer protocols, providing the various mobile applications with basic application domain independent services, such as user interface, application inter-working, and service access security.

The protocol hierarchy of FIG. 2 should be largely encompassed by software architectures that are employed to facilitate internet telephony. Internet telephony consists not only of transmitting speech over packet-based networks, but also includes many other aspects of communications: easy-to-remember addressing, user and service mobility, network presence, instant messaging, and multimedia. In addition to peer-to-peer communications, seamless integration with Web browsing and real-time multimedia streaming are needed for a rich user experience.

In accordance with the present invention, a mobile information server is provided that resides on the mobile platform of IP enabled mobile terminals 108, or alternately, the legacy mobile platform offered by mobile terminal 102. The mobile terminals are addressable within network 100 so that specific services/information may be provided by the mobile terminal to any requesting network entity. The mobile terminals extend the concept of providing static content, such as personal contact information or Pretty Good Privacy (PGP) rings, to providing mobile phone specific dynamic content. In particular, the dynamic content provided by the mobile terminals may be extremely versatile and may provide, for example, network sharing of images captured using internal/external imaging capability of the mobile terminal, extended rich call functionalities, streaming content, telemetry, or information routed from a local area proximity.

The mobile information server according to the present invention may be implemented, for example, by using a Series 60 Platform that is built upon the Symbian Operating System (OS) General Technology (GT). Symbian GT provides a fully object-oriented design, preemptive multi-tasking, and full support for client-server architecture. Symbian GT also provides the common core for API and technology, which is shared between all Symbian reference designs. Some of the major components supported by Symbian GT include a multimedia server for audio recording, playback, and image-related functionality, as well as a Personal Area Network (PAN) communication stack including infrared (IR), Bluetooth and serial communications support. As such, Symbian GT allows the use of Bluetooth technology to allow proximity, wireless operations to utilize local service accessories. The number and type of local service accessories provided by the Bluetooth connection are virtually unlimited and they include for example; bar code readers, digital pens, health monitoring devices, Global Positioning System (GPS) receivers, enhanced video feeds, video conferencing facilitation, local appliance control, security implementations, etc.

Like many other communication technologies, Bluetooth is composed of a hierarchy of components that is formed into the Bluetooth communication stack. The Bluetooth communication stack may be broken into two main components: a Bluetooth Host Controller (BTHC) that provides the lower level of the stack; and a Bluetooth Host (BTH) to send or receive data over a Bluetooth link and to configure the Bluetooth link.

Service Discovery Protocol (SDP) and Radio Frequency Communication (RFCOMM) protocol represent middleware protocols of the Bluetooth stack. RFCOMM protocol allows applications communicating with the Bluetooth stack to treat a Bluetooth enabled device as if it were a serial communications device, in order to support legacy protocols. The RFCOMM protocol defines a virtual set of serial port applications, which allows the RFCOMM protocol to replace cable enabled communications. The definition of the RFCOMM protocol incorporates major parts of the European Telecommunication Standards Institute (ETSI) TS 07.10 standard, which defines multiplexed serial communication over a single serial link. SDP is used to locate and describe services provided by or available through another Bluetooth device, therefore, SDP plays an important role in managing Bluetooth devices in a Bluetooth environment by allowing discovery and service description of services offered within the environment.

The Bluetooth communication stack may represent the lower communication layers that support any number of higher level application embodiments according to the present invention. Referring to FIG. 1, for example, mobile terminal 108 or 102 may each employ a Bluetooth communication stack to facilitate image and voice data transfer, whereby presentation software and camera APIs are implemented as necessary for image generation and display.

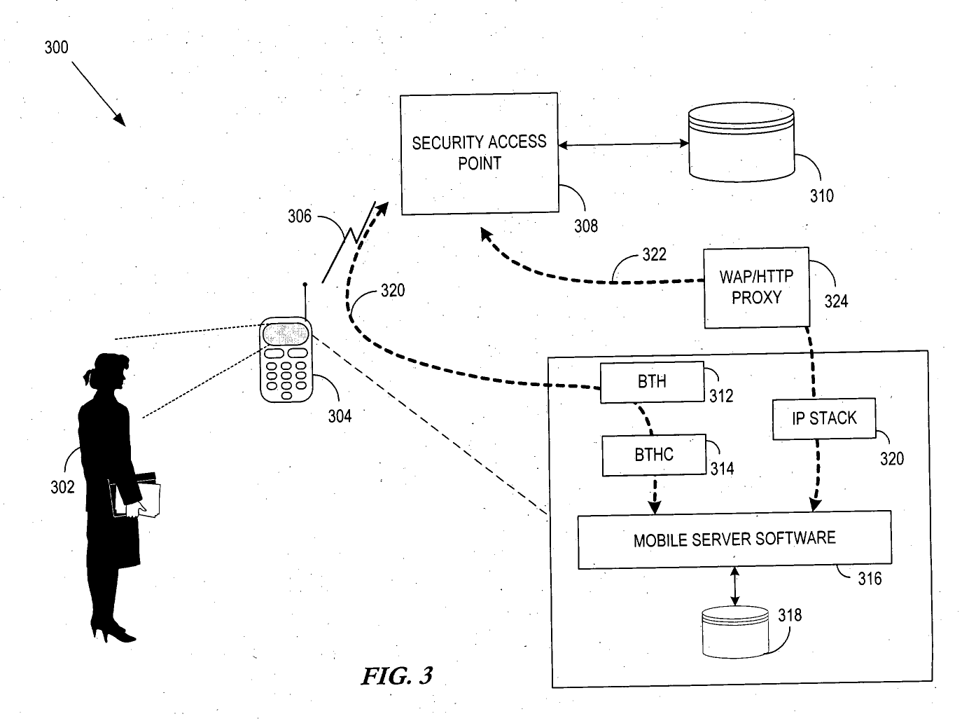

In one embodiment according to the present invention, image enabled mobile terminal 304 having Bluetooth capability is used to provide security access processing 300 as illustrated in FIG. 3. In such an instance, user 302 having image enabled mobile terminal 304 may establish Bluetooth connection 306 between her mobile terminal and security access control point 308 at the entrance of, for example, a secured building (not shown). The user may then capture and store an image of her facial features within database 318 using her mobile terminal and then transfer a digital image of those facial features to access control point 308 via Bluetooth connection 306. Security access control point 308 may then compare the transferred digital image to digital image database 310 of all users having security access to the building. Once a match is found between the transferred digital image and an image contained within digital image database 310, security access control point 308 may facilitate the user's ingress into the building. Otherwise, security access point 308 may deny access to the building and may provide a message indicating the denial of access to the user via Bluetooth connection 306.

Once the image of user 302 has been captured into database 318, mobile terminal 304 may act as an automatic security verification server without the need for user 302 interaction. In particular, as user 302 moves within proximity of security access control point 308 having mobile terminal 304 in her possession, mobile terminal 304 may be automatically contacted via path 320. Bluetooth stacks 312 and 314 establish a connection between security access control point 308 and mobile server software 316, in which security challenges may be issued by security access control point 308 and answered by mobile terminal 304.

In one embodiment, security access point 308 may request, for example, the Joint Photographic Experts Group (JPEG) file containing the previously captured user image from mobile server software 316. The JPEG image is then accessed from database 318 by mobile server software 316 and then transferred to security access point 308 via path 320. Access is either granted or denied based on the comparison of the automatically received image of user 302 to the stored image of user 302 in database 310 as discussed above.

In another embodiment, database 318 may instead contain an encrypted access key or identification string to uniquely identify user 302. Upon automatically establishing Bluetooth connection 306 when user 302 is in close proximity to security access control point 308, security access control point 308 challenges mobile server software 316 for the identification string. Upon receipt of the identification string, security access control point 308 may then grant or deny access to user 302 based on security processing performed using the identification string.

It should be noted that once mobile terminal 304 contains the required security information needed by security access control point 308, no user interaction is required in order for access verification to take place. It should also be noted that Bluetooth connection 306 is not necessarily required to gain security access information from mobile terminal 304 by security access control point 308. In one embodiment, for example, security access control point 308 may have connectivity to WAP/HTTP proxy 324, in which HTTP requests may be made to mobile terminal 304 through IP stack 320. In this case, mobile terminal 304 is acting as a mobile security verification server, whereby user 302 merely provides the address, e.g., IP address or URL, of mobile terminal 304 to security access control point 308 so that the security credentials may be accessed. The address of mobile terminal 304 may be provided through user 302 interaction with security access control point 308 through, for example, entry of her Personal Identification Number (PIN) into a key pad (not shown). The PIN is then used by security access control point 308 as a lookup index into database 310 containing the address of mobile terminal 304. Once the address is obtained, a WAP/HTTP request may be generated via path 322 to obtain security credentials from database 318 via mobile server software 316 and IP stack 320.

Mobile terminal 304 may communicate with other appliances as well using its Bluetooth capabilities. In one embodiment, mobile terminal 304 may establish a Bluetooth connection to, for example, a refrigerator that contains a required number of edible products which must be kept at cold temperatures, such as milk, butter, eggs, poultry, etc. Once the Bluetooth connection between mobile terminal 304 and the refrigerator has been established, the refrigerator may upload to mobile terminal 304 an inventory of the quantity of products currently contained within the refrigerator. Once uploaded, mobile terminal 304 may format the data into a shopping list that may be referenced by the user of mobile terminal 304 during his or her next visit to the grocery market.

In an alternate embodiment according to the present invention, video conferencing scenario 400 illustrates the parties of meeting group 402 remotely linked to presenter 414 via WLAN connections 416, 422, and Internet 408. Meeting group 402 and presenter 414 are spatially removed from one another, such as may be the case when a corporation has a number of production and engineering facilities that are geographically located across the globe from one another. In a particular case, for example, meeting group 402 may represent a group of lower level production management personnel located within the United States, who have assembled to receive and discuss the ideas presented by senior production manager 414 located at the corporation's headquarters.

In such an example, meeting group 402 and presenter 414 are not equipped with standard video conferencing equipment, but are equipped with imaging capable mobile terminals 404 and 412. In addition, image processing capable PCs 406 and 410 are provided to meeting group 402 and presenter 414 via WLAN connections 416 and 422, respectively. PCs 406 and 410 exchange audio and video information with each other via Internet connections 418 and 420, whereby the respective audio and video information that was previously gathered is exchanged via WLAN connections 416 and 422, respectively. Each of PCs 406 and 410 are equipped with, for example, conferencing software such as NetMeeting or Timbuktu Pro, that allows audio/video data to be exchanged between them in order to create a virtual meeting between meeting group 402 and presenter 414. Since PCs 406 and 410 are not equipped with their own video capturing device, imaging enabled mobile terminals 404 and 412 are used instead.

Mobile terminals 404 and 412 may also be equipped with video/audio storage capability such that the various meeting transactions depicted in video conferencing scenario 400 may be recorded. In such an instance, the recorded audio/video content may be re-played by either of mobile terminals 404 and/or 412 via an audio/video stream to a remote network entity at some time after the conclusion of the conference. If terminal 114 of FIG. 1, for example, participated in conferencing scenario 400, then a desk top computer operating within Internet 138 of FIG. 1, for example, may access the audio/video content contained within mobile terminal 114. Alternately, a large number of terminals having Internet access may retrieve the audio/video feeds from mobile terminal 114 at one time via streaming and multicasting technology. In such an instance, mobile terminal 114 is operating as a streaming server supplying both audio and video feeds to any interested clients.

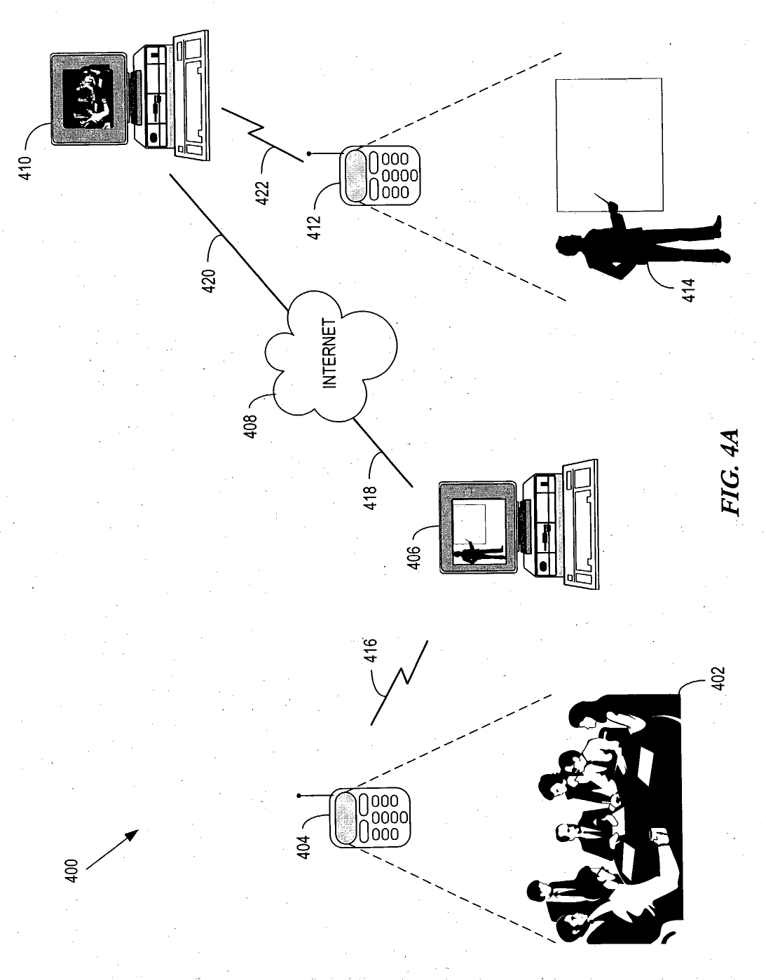

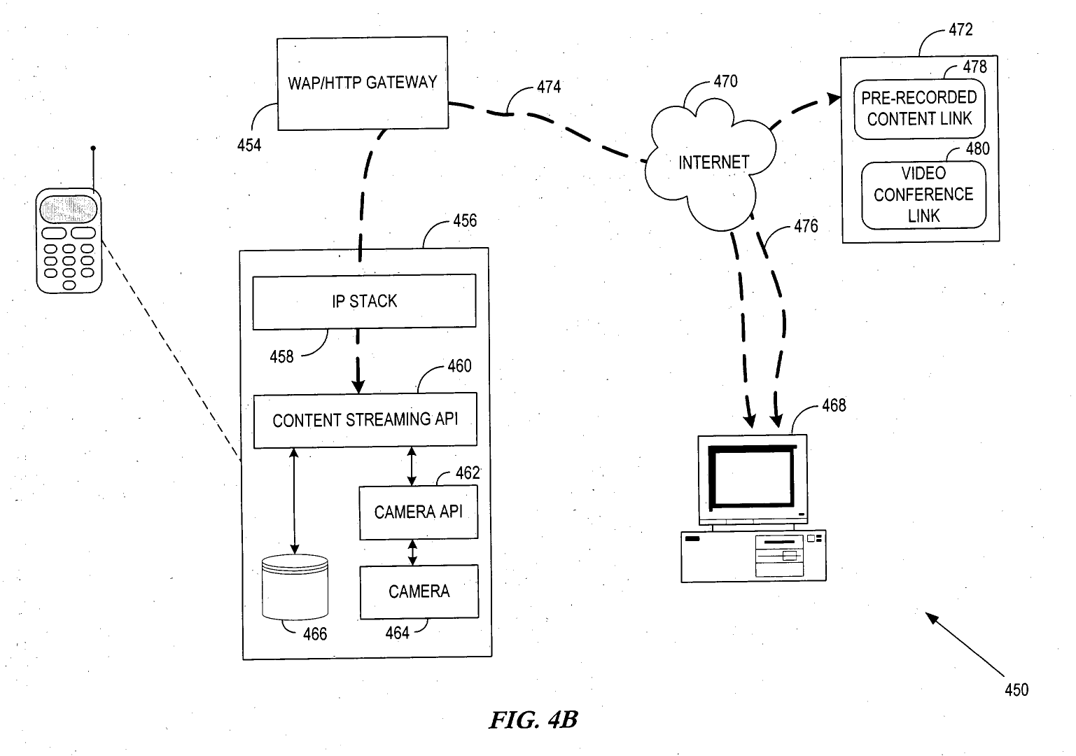

FIG. 4B illustrates alternative embodiment 450 whereby mobile terminal 456 acts as a streamed content server according to the present invention. Content may either be pre-recorded and stored within database 466 as depicted in the recorded video conferencing session of FIG. 4A, or may be provided live using camera 464 and camera Application Programming Interface (API) 462. In this embodiment, mobile terminal 456 is directly supplying audio/video content through a streaming protocol, such as RTSP located within IP stack 458, via content streaming API 460 to an Internet user, e.g., PC 468.

The user of mobile terminal 456 may, for example, maintain a separate Web page 472 located within Internet 470. Located within the user's home page 472 exists several links to a URL or IP address that points to mobile server 456. A first link to mobile server 456 may be a link to pre-recorded content 478 that has been stored within database 466. A second link to mobile server 456 may be a video conference link 480 that may be used to instantiate a live video conference session with the user of mobile server 456.

Access to an audio/video streaming session with mobile server 456 may be instantiated through usage of PC 468 to gain access to home page 472. A browsing session using HTTP via path 476 may, for example, lead a user of PC 468 to Web page 472. Access to Web page 472 may require authorization and authentication, since it provides a direct link to content stored within and/or created by mobile server 456. Once the required RTSP links and mobile server 456 IP address or URL has been obtained from links 478 and/or 480 via path 476, the actual streaming session request may be initiated by PC 468 via path 474 through WAP/HTTP gateway 454.

If pre-recorded content has been requested, content streaming API 460 retrieves the pre-recorded content from database 466 and delivers the content via path 474 to PC 468. Path 474 is also used for video conferencing feeds, except that the video data is derived from camera 464 and camera API 462. In the case that PC 468 has requested a video conference with the user of mobile server 456, content streaming API 460 of mobile server 456 may first contact the user of mobile server 456, so that the user of mobile server 456 may properly arrange camera 464 to provide the requested live video stream in support of the requested video conference.

Streaming refers to delivering different media types as real-time streams using IP protocols via, for example, RTSP 244 of FIG. 2. The content could be music files, real time Internet radio broadcasts, movies, real-time video conferencing feeds, or pre-recorded audio/video media. Most streaming technologies are based on RTSP, which offers a way of controlling the streamed presentation, e.g., seeking and pausing, whereas SIP is used for initiating the sessions. The RTSP stack is divided into three modules: MSG, RTSP, and NTR/MSS. The MSG module interface handles generic message parsing and is also used with SIP. The RTSP module is similar to the SIP module and has functions for encoding and decoding header strings for structures and vice versa. NTR contains the agent and session objects which manage the sending and receiving of messages. The Media Subsystem (MSS) module controls the media processing of the top layer of the stack.

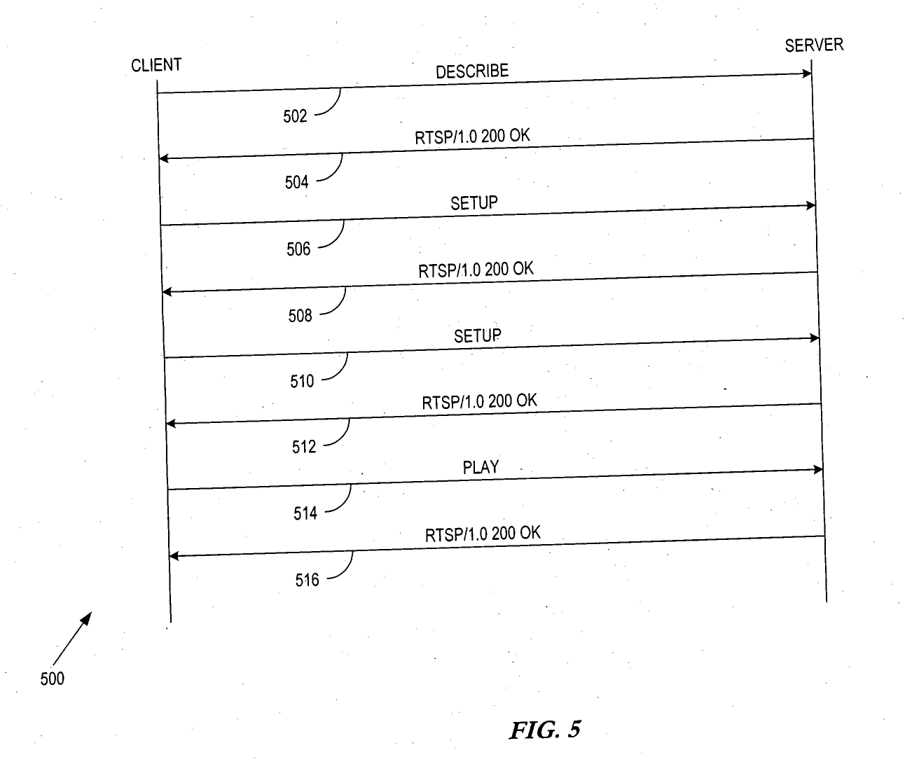

FIG. 5 illustrates a typical RTSP message flow that controls a streaming session between, for example, mobile terminal 114 (server) and laptop computer 118 (client). The streaming session may be set up using SIP, for example, between mobile terminal 114 and laptop computer 118 of FIG. 1, where mobile terminal 114 has previously recorded the conferencing session illustrated in FIG. 4A. In this case, mobile terminal 114 is acting as a mobile information server by supplying pre-recorded audio/video data to client laptop computer 118. SIP related messaging has not been included in the message flow of FIG. 5.

For purposes of this embodiment, a container file is used by mobile terminal 114. A container file is a storage entity in which multiple continuous media types pertaining to the same conference session are present. In effect, the container file represents an RTSP presentation, with each of its components being RTSP streams. While the components are transported as independent streams, it is desirable to maintain a common context for those streams at the server end, so that the server may easily keep a single storage handle open. It also allows treating all the streams equally in case of any prioritization of streams by the server, e.g., mobile terminal 114. Table 1 defines the messages 502-516 of FIG. 5.

TABLE 1

| MESSAGE | CONTENTS |
|---|---|
| 502 | DESCRIBE rtsp://server/conference RTSP/1.0 |
| | CSeq: 1 |
| 504 | RTSP/1.0 200 OK |
| | CSeq: 1 |
| | Content-Type: application/sdp |
| | Content-Length: 164 |
| | v=0 |
| | o=- 2890844256 2890842807 172.16.2.93 |
| | s=RTSP Session |
| | i=Conference call of FIG. 4A |
| | a=control:rtsp://server/conference |
| | t=0 0 |
| | m=audio 0 RTP/AVP 0 |
| | a=control:rtsp://server/conference/audio |
| | m=video 0 RTP/AVP 26 |
| | a=control:rtsp://server/conference/video |
| 506 | SETUP rtsp://server/conference/audio RTSP/1.0 |
| | CSeq: 2 |
| | Transport:RTP/AVP;unicast;client_port=8000-8001 |
| 508 | RTSP/1.0 200 OK |
| | CSeq: 2 |
| | Transport:RTP/AVP;unicast;client_port=8000-8001; |
| | server_port=9000-9001 |
| | Session: 12345678 |
| 510 | SETUP rtsp://server/conference/video RTSP/1.0 |
| | CSeq: 3 |
| | Transport:RTP/AVP;unicast;client_port=8002-8003 |
| | Session: 12345678 |
| 512 | RTSP/1.0 200 OK |
| | CSeq: 3 |
| | Transport:RTP/AVP;unicast;client_port=8002-8003; |
| | server_port=9004-9005 |
| | Session: 12345678 |
| 514 | PLAY rtsp://server/conference RTSP/1.0 |
| | CSeq: 4 |
| | Range: npt=0- |
| | Session: 12345678 |
| 516 | RTSP/1.0 200 OK |
| | CSeq: 4 |
| | Session: 12345678 |
| | RTP-Info: url=rtsp://server/conference/video; |
| | seq=9810092;rtptime=3450012 |

In message 502, laptop 118 is requesting a description of the stream “conference” at location “//server”, which is, for example, the default server directory for audio/video feeds from mobile terminal 114. In message 504, mobile terminal 114 responds with a Session Description Protocol (SDP) description of the stream “conference”. Two media descriptions are defined, e.g., audio and video, with the transport specified as RTP/Audio Video Protocol (AVP) and separate control is setup for each. Messages 506 and 508 make up call sequence 2, whereby the client and server ports for the audio stream are requested and acknowledged by the client and server, respectively. Messages 510 and 512 make up call sequence 3, whereby the client and server ports for the video stream are requested and acknowledged by the client and server, respectively. Messages 514 and 516 makeup the client's instruction to playback the recorded version of the conference session, whereby laptop computer 118 has requested mobile terminal 114 to playback the entire portion of the recorded conference session.

In another embodiment according to the principles of the present invention, the mobile terminal providing the information resource acts as an HTTP server, whereby other network terminals or Internet browsers operating within network 100 of FIG. 1 may access information from mobile terminals operating as HTTP servers through the use of HTTP. The user of a mobile terminal operating as an HTTP server, for example, may publish an information resource such as a home page in Wireless Markup Language (WML) or eXtensible HyperText Markup Language (XHTML), or other information resources such as image/video content; telemetry information; and may further define access controls to the information resource.

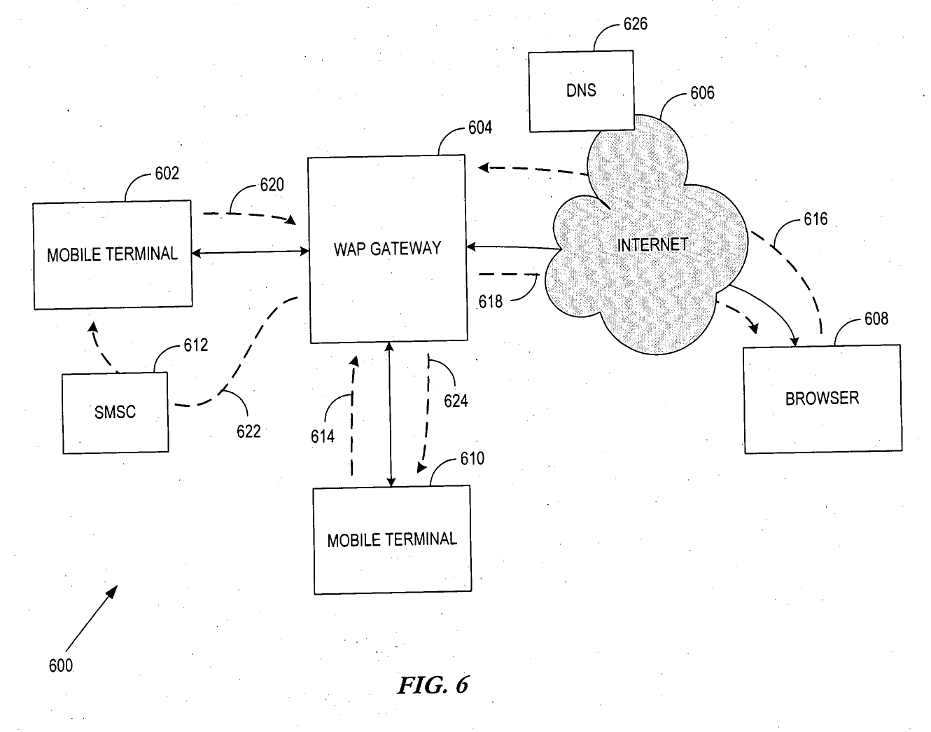

FIG. 6 illustrates mobile server relationship 600 in accordance with the principles of the present invention. Mobile terminal 602, for example, may be operating as an HTTP server, whereby mobile terminal 610 and browser 608 are able to access information resources stored within mobile terminal 602 via WAP gateway 604.

An HTTP request message is generated by a client, e.g., browser 608, and is delivered to a server, e.g., mobile terminal 602, in accordance with the principles of the present invention. The components of the HTTP request message are illustrated in Table 2, where included within the first line of the request message is the Request-Line, which defines the method to be applied to the resource, the Uniform Resource Identifier (URI) of the resource, and the protocol version in use. The method tag includes values: “OPTIONS”; “GET”; “HEAD”; “POST”; “PUT”; “DELETE”; “TRACE”; and “CONNECT”. The “GET” method retrieves whatever information (in the form of an entity) that is identified by the Request-URI. If the Request-URI refers to a data-producing

TABLE 2

| Request | |
|---|---|
| Message | Description |
| request-line | Contains the method, request-URI, and the HTTP |
| | Version |
| general-header | General applicability to request and response messages |
| request-header | Allows client to pass additional information about request |
| entity-header | Defines meta information about the entity body |
| message-body | Carries the entity body associated with the request |

process, for example, it is the produced data which is returned as the entity in the response and not the source text of the process, unless the source text happens to be the output of the process. The “POST” method is used to request that the origin server accept the entity enclosed in the request as a new subordinate of the resource identified by the Request-URI in the Request-Line. “POST” is designed to allow a uniform method to cover the following functions: annotation of existing resources; posting a message to a bulletin board, newsgroup, mailing list, or similar group of articles; providing a block of data, such as the result of submitting a form to a data-handling process; or extending a database through an append operation. The actual function performed by the POST method is determined by the server and is usually dependent on the Request-URI. The posted entity is subordinate to that URI in the same way that a file is subordinate to a directory containing it, a news article is subordinate to a newsgroup to which it is posted, or a record is subordinate to a database.

There are a few header fields which have general applicability for both request and response messages, but which do not apply to the entity being transferred. These header fields apply only to the message being transmitted and they are found in the general-header field of the HTTP request message. The request-header field allows the client to pass additional information about the request, and about the client itself, to the server. These fields act as request modifiers, with semantics equivalent to the parameters on a programming language method invocation. Entity-header fields define meta information about the entity-body or, if no body is present, about the resource identified by the request. Some of the meta information is optional and some might be required by portions of the particular HTTP version being used.

The message-body (if any) of an HTTP message is used to carry the entity-body associated with the request or response. The message-body differs from the entity-body only when a transfer-coding has been applied, as indicated by the Transfer-Encoding header field (not shown). Transfer-Encoding must be used to indicate any transfer-coding applied by an application to ensure safe and proper transfer of the message. Transfer-Encoding is a property of the message, not of the entity, and thus may be added or removed by any application along the request/response chain. The presence of a message-body in a request is signaled by the inclusion of a Content-Length or Transfer-Encoding header field in the request's message-headers. A message-body must not be included in a request if the specification of the request method does not allow sending an entity-body in requests. A server should read and forward a message-body on any request; if the request method does not include defined semantics for an entity-body, then the message-body should be ignored when handling the request.

An exemplary HTTP request line using the “GET” tag is illustrated in the following request line: “GET http://1.2.3.4/TheFile.html HTTP/1.1”. The request line includes URI pathname, “http://1.2.3.4/” , where “1.2.3.4” is the IP address associated with mobile terminal 602 and the file “TheFile.html” is to be retrieved as a result of the “GET” request from mobile terminal 602. Alternatively, the HTTP GET request may take the form of “http://identifier” or “http: identifier.domain-name”, where the “identifier” portion of the URI pathname reflects the Mobile Station Integrated Services Digital Network Number (MSISDN) of mobile terminal 602 and the “domain-name” portion of the URI pathname reflects the domain name of WAP gateway 604 in the operator network. The “domain-name” portion of the URI pathname may be omitted, for example, when mobile terminal 610 is in the same operator network as mobile terminal 602. The HTTP request message may be delivered via path 616 from browser 608 or via path 614 from mobile terminal 610. Domain Name Server (DNS) 626 may be utilized to convert the domain name contained within the URI pathname to the actual IP address of WAP gateway 604. For example, the following wildcard entry may be used to facilitate the conversion from the URI pathname provided by browser 608, for example, to the IP address of WAP gateway 604: “*.wap.sonera.net A 5.6.7.8”. The “*” is a wildcard that allows all request lines having URI pathnames that contain domain portions equal to “wap.sonera.net” to be routed to WAP gateway 604, since IP address “5.6.7.8” is supplied by DNS 626 in response to domain requests for “wap.sonera.net”.

After receiving the HTTP requests, WAP gateway 604 proxies the request to mobile terminal 602 through, for example, SMSC 612 via path 622. In addition, WAP gateway 604 also sends the MSISDN of mobile terminal 610 (in the event that the HTTP request was received from mobile terminal 610) to mobile terminal 602 for authentication and authorization of mobile terminal 610. If, on the other hand, the HTTP request was received from browser 608, then WAP gateway 604 checks to see whether an HTTP Authorization header is included. If not, WAP gateway 604 will send a response with status 401 UNAUTHORIZED to browser 608, and will include a WWW-Authenticate header field containing a challenge asking for a user password from browser 608.

Once the HTTP Authorization header is received from browser 608, WAP gateway 604 forwards it to mobile terminal 602 for authentication. Since mobile terminal 602 is acting as the information server, it first checks the access rights of the requesting terminal. If the requesting terminal is authenticated, mobile terminal 602 forwards the content indicated by the Request-URI to WAP gateway 604 via message 620. WAP gateway 604 then encapsulates the content received from mobile terminal 602 into an HTTP response and transmits the HTTP response to the requesting terminal via either path 618 or 624. The user of mobile terminal 602 is not necessarily involved with the data access process, but sets the access rights control rules for the information resources being provided. The implementation of the access control rules is dependent upon the particular mobile terminal in use.

Mobile terminal 602 may utilize its server relationship with mobile terminal 610 and browser 608 in any number of different ways. In one embodiment, mobile terminal 602 may act as an image server, whereby the file “TheFile.html” contains pointers to image files that were previously captured with a camera internal to mobile terminal 602. In this case, the images are accessible by virtually any browser having HTML, XHTML, WML, etc. capability. If global access to the images is not desired, security measures may be put into place in order to restrict access to the images to only a select few.

In another embodiment, mobile terminal 602 and mobile terminal 610 may be conducting a rich content call session. While exchanging verbal communication, the user of mobile terminal 602 may supply the user of mobile terminal 610 with a URL that contains “TheFile.html”. While continuing to communicate with the user of mobile terminal 602, the user of mobile terminal 610 may locate the URL with the browser executing within mobile terminal 610 and download the images contained within. Likewise, the user of mobile terminal 602 may snap a picture while communicating with the user of mobile terminal 610 and then may supply the picture in real time to the user of mobile terminal 602.

In another embodiment, mobile terminal 602 may publish its own telemetry information for consumption by a selected or wider audience. For example, information concerning telephone state, location, selected user profile, call usage registers, battery level, and outside temperature are all possible and potential information to be published using mobile terminal 602. Such telemetry information may be useful, for example, to determine the mobile terminal's actual location, to estimate the amount of the user's next phone bill, and to correlate the measured outside temperature with the mobile terminal's location to provide real-time meteorological data.

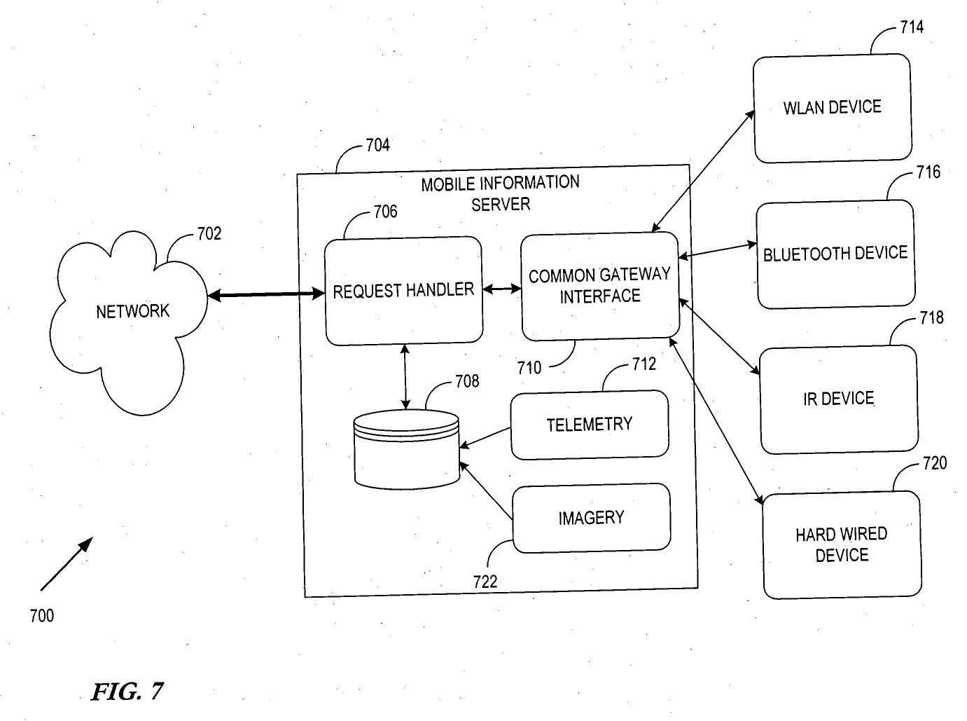

Generally speaking, the Mobile Information Server (MIS) according to the present invention may also be used as a gateway to a multitude of devices that are directly accessible by MIS 704 as illustrated in network diagram 700 of FIG. 7. Common Gateway Interface (CGI) 710 interfaces external applications 714-720 to network 702. Network 702 may access MIS 704 via, for example, HTTP or WAP requests, which are parsed by request handler 706. If the information requested is locally accessible via, for example, server directory 708, then the information is accessed from server directory 708 and the request is fulfilled with the data acquired from server directory 708. If, on the other hand, the requested data is to be accessed from remote devices 714-720, then CGI 710 is required to provide the gateway to these devices.

In particular, a typical HTTP request from network 702 may take the form “GET http://1.2.3.4/cgi-bin/conf_recorder HTTP/1.1”, for example, where “1.2.3.4” is the IP address of MIS 704. “cgi-bin” is the pathname to CGI 710 where the “conf_recorder” file can be found. “conf_recorder” may be a configuration file that is updated by a video recorder (not shown), for example, that is accessible as IR device 718. In other words, the configuration data for the video recorder (not shown) can be read and written through the use of HTTP requests received from network 702. Using the HTTP GET request above, for example, the “conf_recorder” file may be retrieved from CGI 710 and the current configuration of the video recorder may be known by any requesting device within network 702. Similarly, the requesting device within network 702 may configure the video recorder by using the corresponding HTTP POST procedure to replace the “conf_recorder” file with a new configuration definition. CGI 710 provides all necessary conversion to encapsulate the parameters contained within “conf_recorder” into an appropriate HTTP response to be sent to the requesting device in network 702. COI 710 also provides all necessary conversion to convert configuration data sent from the requesting device into the IR protocol, for example, that is required by the IR device, e.g., video recorder.

Other devices, such as WLAN device 714, may also be connected to MIS 704 via CGI 710. Since most WLAN devices provide an HTTP stack, CGI 710 may not be required for protocol conversion of HTTP requests coming from network 702 and bound for WLAN device 714, but may instead provide any necessary security measures to protect network access to WLAN device 714. Similarly, CGI 710 may provide the HTTP/Bluetooth protocol conversion necessary for HTTP compliant devices within network 702 to consume data from Bluetooth device 716. Hard wired device 720 may represent any device that is hardwired to MIS 704 via, for example, RS232, RS485, FireWire, Universal Serial Bus (USB), etc., whereby CGI 710 provides the necessary conversion from, for example, HTTP to the corresponding RS232, RS485, FireWire, or USB protocols.

Information locally generated by MIS 704 may also be delivered to network 702. In particular, MIS 704 may comprise telemetry gathering device 712 and/or imagery gathering device 722. Telemetry gathering device may compile information that describes the current state of MIS 704 such as its telephony state, geographic location, selected user profile, value of its call usage register, battery level, or outside temperature. Similarly, imagery device 722 may generate still images or video clips that may be stored within server directory 708. All data stored within server directory 708 may be shared for network 702 access, or protected to limit access to a smaller set of network entities within network 702.

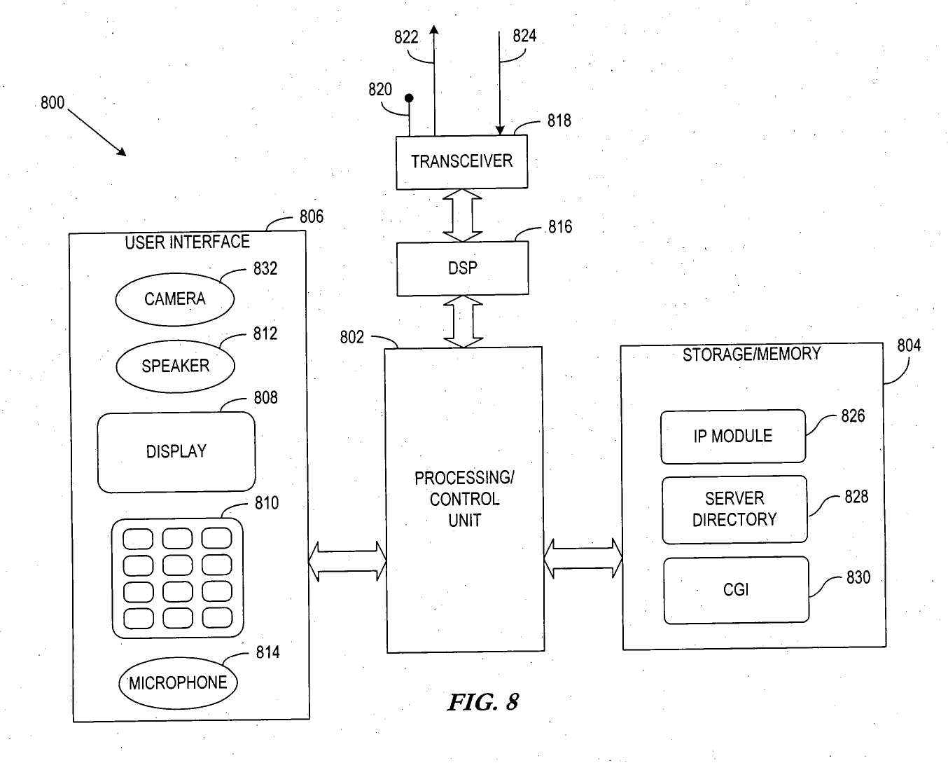

The invention is a modular invention, whereby processing functions within a mobile terminal may be utilized to implement the present invention. The mobile devices may be any type, of wireless device, such as wireless/cellular telephones, personal digital assistants (PDAs), or other wireless handsets, as well as portable computing devices capable of wireless communication. These landline and mobile devices utilize computing circuitry and software to control and manage the conventional device activity as well as the functionality provided by the present invention. Hardware, firmware, software or a combination thereof may be used to perform the various mobile server functions described herein. An example of a representative mobile terminal computing system capable of carrying out operations in accordance with the invention is illustrated in FIG. 8. Those skilled in the art will appreciate that the exemplary mobile computing environment 800 is merely representative of general functions that may be associated with such mobile devices, and also that landline computing systems similarly include computing circuitry to perform such operations.

The exemplary mobile computing arrangement 800 suitable for implementing mobile server functions in accordance with the present invention may be associated with a number of different types of wireless devices. The representative mobile computing arrangement 800 includes a processing/control unit 802, such as a microprocessor, reduced instruction set computer (RISC), or other central processing module. The processing unit 802 need not be a single device, and may include one or more processors. For example, the processing unit may include a master processor and associated slave processors coupled to communicate with the master processor.

The processing unit 802 controls the basic functions of the mobile terminal, and also those functions associated with the present invention as dictated by IP module 826, server directory 828, and CGI 830 available in the program storage/memory 804. Thus, the processing unit 802 is capable of supplying mobile server content stored in server directory 828, or remotely accessible through CGI 830, to requesting client terminals via IP protocols implemented by IP module 826. The program storage/memory 804 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the present invention, the program modules associated with the storage/memory 804 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be transmitted to the mobile computing arrangement 800 via data signals, such as being downloaded electronically via one or more networks, such as the Internet and an intermediate wireless network(s).

The processor 802 is also coupled to user-interface 806 elements associated with the mobile terminal. The user-interface 806 of the mobile terminal may include, for example, a display 808 such as a liquid crystal display, a keypad 810, speaker 812, internal camera 832, and microphone 814. These and other user-interface components are coupled to the processor 802 as is known in the art. Other user-interface mechanisms may be employed, such as voice commands, switches, touch pad/screen, graphical user interface using a pointing device, trackball, joystick, or any other user interface mechanisms.

The mobile computing arrangement 800 also includes conventional circuitry for performing wireless transmissions. A digital signal processor (DSP) 816 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 818, generally coupled to an antenna 820, transmits the outgoing radio signals-822 and receives the incoming radio signals 824 associated with the wireless device.

The mobile computing arrangement 800 of FIG. 8 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a mobile server system and apparatus in accordance with the present invention.

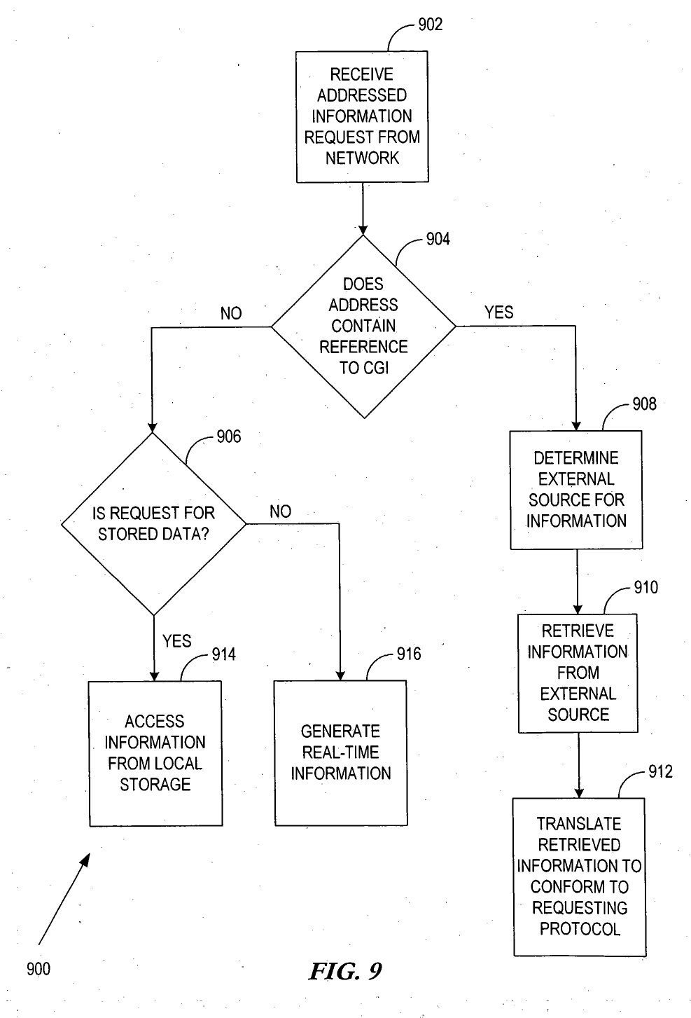

Referring now to FIG. 9, request processing method 900 in accordance with the principles of the present invention is illustrated. The method is explained in combination with FIG. 7. In step 902, an addressed information request is received having a format as illustrated in Table 2, for example. The URL of the request is parsed in step 904 to determine whether a reference is made to the cgi-bin directory of CGI interface 710. If not, then information is either accessed from server directory 708 as in step 914 or real-time information is generated in step 916. If the information request does involve data access from an external device, then the YES path of step 904 is taken and the external source of the information, e.g. external devices 714-720, is determined in step 908.

Data is accessed by mobile information server 704 from external devices 714-720 in response to data requests from network 702 as in step 910. Depending upon the information source, CGI 710 is required to perform a data translation on the retrieved data, such that the retrieved data is compatible with the requesting protocol. For example, if the sourcing device is Bluetooth device 716, then an RFCOMM connection may have been established between CGI 710 and Bluetooth device 716, whereby a serial data socket is used for the data transfer. Once received, the serial data must then be binary encoded into the MIME format and encapsulated into the HTTP message part of the HTTP response generated by CGI 710 as in step 912.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

1. A mobile information system to provide information to network entities within a network, the mobile information system comprising:
a mobile information server arranged to receive addressed information requests from the network entities; and
at least one information source, wherein the mobile information server facilitates information exchange from the at least one information source in response to the addressed information requests from the network entities.

2. The mobile information system according to claim 1, wherein the at least one information source is internal to the mobile information server.

3. The mobile information system according to claim 2, wherein the at least one information source contains information generated by the mobile information server.

4. The mobile information system according to claim 3, wherein the information generated by the mobile information server includes image data captured by the mobile information server.

5. The mobile information system according to claim 3, wherein the information generated by the mobile information server includes telemetry data related to the mobile information server.

6. The mobile information system according to claim 1, wherein the at least one information source is external to the mobile information server.

7. The mobile information system according to claim 6, wherein the mobile information server exchanges information with any of a Wireless Local Area Network (WLAN), Bluetooth, Infrared (IR), or hard wired device.

8. The mobile information system according to claim 7, wherein information exchanged with the Bluetooth device is used to support a security access system.

9. The mobile information system according to claim 7, wherein the information exchanged with the WLAN device is used to support a video conferencing system.

10. A mobile terminal wirelessly coupled to a network which includes a network element capable of requesting information from the mobile terminal through the use of addressed requests to the mobile terminal, the mobile terminal comprising:
a memory capable of storing at least a protocol module, a server directory containing requested information, and a Common Gateway Interface (CGI);
a processor coupled to the memory and configured by the protocol module to provide the requested information to the network element in response to the information request; and
a transceiver configured to facilitate the requested information exchange with the network element.

11. The mobile terminal according to claim 10, further comprising an imaging device arranged to capture images for storage in the server directory.

12. The mobile terminal according to claim 10, further comprising a telemetry device arranged to capture telemetry data for storage in the server directory.

13. The mobile terminal according to claim 10, wherein the CGI facilitates information transfer with any of a Wireless Local Area Network (WLAN), Bluetooth, Infrared (IR), or hard wired device.

14. The mobile terminal according to claim 13, wherein information transfer with the Bluetooth device facilitates communication with a security access point.

15. The mobile terminal according to claim 13, wherein information transfer with the WLAN device facilitates video conferencing.

16. A computer-readable medium having instructions stored thereon which are executable by a mobile information server for facilitating information transfer to network elements by performing steps comprising:
receiving information requests from the network elements;
determining a source for the information requested;
accessing the information from the determined source; and
conducting a transfer of the requested information to the network elements.

17. A method of providing information from a mobile server to requesting network elements, comprising:
receiving information requests from the network elements by the mobile server;
determining a source for the information requested;
accessing the information from the determined source; and
transferring the requested information to the network elements from the mobile server.

18. The method according to claim 17, wherein the information requests received are addressed to the mobile server.

19. The method according to claim 18, wherein the address includes an Internet Protocol address.

20. The method according to claim 18, wherein the address includes a Mobile Station Integrated Services Digital Network Number (MSISDN).

21. The method according to claim 17, wherein the determined source is internal to the mobile information server.

22. The method according to claim 18, wherein the determined source is external to the mobile information server.

23. The method according to claim 22, wherein the address contains a reference to a Common Gateway Interface (CGI).

24. The method according to claim 23, wherein the CGI performs a protocol conversion between an information request protocol used by the network elements and a protocol used by the external information source.

25. The method according to claim 17, wherein transferring the information includes using a streaming protocol.
